(19) United States
(12) Patent Application Publication
(10) Pub. No.: US 2026/0052285 A1
(43) Pub. Date: Feb. 19, 2026

(54) MINIMIZING SLATE WITHIN AD PODS RETURNED FOR AD REQUEST RELATING TO BREAK IN STREAMING VIDEO CONTENT

(71) Applicant: Samsung Electronics Co., Ltd., Suwon-si (KR)

(72) Inventors: Avner Ronen, Nyack, NY (US); Andrew Joseph Dickerson, Allen, TX (US); Jeffrey L. Wilkinson, Flower Mound, TX (US)

(21) Appl. No.: 18/807,422

(22) Filed: Aug. 16, 2024

(51) Int. Cl. H04N 21/234; H04N 21/478; H04N 21/81

(52) U.S. Cl. CPC H04N 21/23424; H04N 21/4781; H04N 21/812

(57) ABSTRACT

A video content server includes a transceiver configured to receive an ad request for advertising to be displayed during an ad break for streaming of video content to an electronic device. The video content server also includes at least one processing device configured, in response to receiving an indication of zero or more ads returned for the ad request, to determine that an overall duration of the zero or more ads returned for the ad request leave an unfilled portion of the ad break. The at least one processing device is also configured to combine, with the zero or more ads returned for the ad request, an interactive ad that is expanded or contracted to fit the unfilled portion of the ad break. The interactive ad includes ad content that can change based on user interaction with the ad content.

### TECHNICAL FIELD

This disclosure relates generally to advertising during streaming of video content. More specifically, this disclosure relates to minimizing slate within ad pods returned for an ad request relating to an ad break in streaming video content.

### BACKGROUND

With the rise of free, ad-supported streaming video content and other media experiences looking to generate revenue via ads, there is more competition on current ad demand and ad supply. Ultimately, existing advertising supply techniques lead to missed ad opportunities and loss of revenue. An example occurs when an ad break is unable to fill a scheduled break time with an ad unit, resulting in a portion of the ad break being filling with “slate.” Slate refers to content in one or more gaps in an ad break that could not be otherwise filled with a dynamically-served ad, and that practice results in no revenue while slate is on-screen. Ideally, all ad-supported streaming video content would display zero slate during ad breaks, which is challenging for several reasons. For example, multiple parties and technologies are generally involved in inserting an ad. While industry standards such as VAST allow for a standard protocol between systems, ad supply varies from ad break to ad break such that situations may arise in which no ad is supplied. Even if ads are returned at an ad break, the number of ads, the duration of those ads, or both can vary for every ad break and for each user. Additionally, for a variety reasons, not all of the ad units returned may be shown in an ad break.

### SUMMARY

This disclosure relates to minimizing slate within ad pods returned for an ad request relating to an ad break in streaming video content.

In a first embodiment, a method includes receiving an ad request for advertising to be displayed during an ad break for streaming of video content to an electronic device. The method also includes, in response to receiving an indication of zero or more ads returned for the ad request, determining, using at least one processor, that an overall duration of the zero or more ads returned for the ad request leave an unfilled portion of the ad break. The method further includes combining, using at least one processor, the zero or more ads returned for the ad request with an interactive ad that is expanded or contracted to fit the unfilled portion of the ad break. The interactive ad includes ad content that can change based on user interaction with the ad content.

In a second embodiment, a video content server includes a transceiver configured to receive an ad request for advertising to be displayed during an ad break for streaming of video content to an electronic device. The video content server also includes at least one processing device configured, in response to receiving an indication of zero or more ads returned for the ad request, to determine that an overall duration of the zero or more ads returned for the ad request leave an unfilled portion of the ad break. The at least one processing device is also configured to combine, with the zero or more ads returned for the ad request, an interactive ad that is expanded or contracted to fit the unfilled portion of the ad break. The interactive ad includes ad content that can change based on user interaction with the ad content.

In a third embodiment, a non-transitory machine readable medium contains instructions that when executed cause at least one processor of an electronic device to receive an ad request for advertising to be displayed during an ad break for streaming of video content to an electronic device. The non-transitory machine readable medium also contains instructions that when executed cause the at least one processor, in response to receiving an indication of zero or more ads returned for the ad request, to determine that an overall duration of the zero or more ads returned for the ad request leave an unfilled portion of the ad break. The non-transitory machine readable medium further contains instructions that when executed cause the at least one processor to combine, with the zero or more ads returned for the ad request, an interactive ad that is expanded or contracted to fit the unfilled portion of the ad break. The interactive ad includes ad content that can change based on user interaction with the ad content.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device employed to dynamically supply interactive ads with minimized slate in accordance with this disclosure;

FIGS. 2A through 2C illustrate example scenarios of dynamically supplied interactive ads with minimized slate in accordance with this disclosure;

FIG. 3 illustrates an example process for dynamically supplying interactive ads with minimized slate in accordance with this disclosure;

FIG. 4 illustrates an example high-level architecture for dynamically supplying interactive ads with minimized slate in accordance with this disclosure;

FIGS. 5A and 5B illustrate an example process for dynamically supplying interactive ads with minimized slate in accordance with this disclosure;

FIG. 6 illustrates another example high-level architecture for dynamically supplying interactive ads with minimized slate in accordance with this disclosure;

FIGS. 7A and 7B illustrate an example process for dynamically supplying interactive ads with minimized slate in accordance with this disclosure;

FIG. 8 illustrates an example process for VAST response evaluation in accordance with this disclosure; and

FIG. 9 illustrates an example process for an Ad Exchange request/response in accordance with this disclosure.

### DETAILED DESCRIPTION

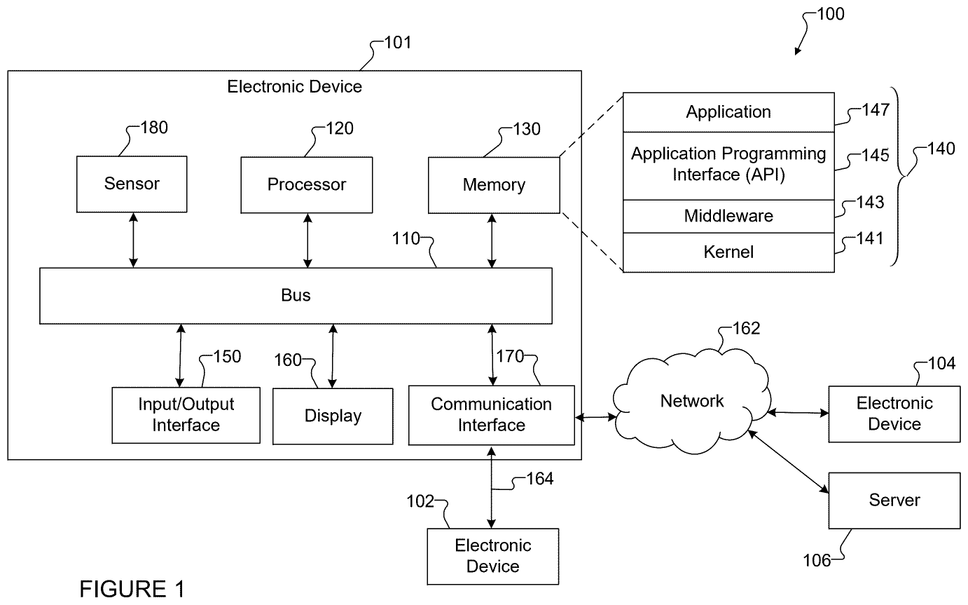

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

Definitions

| | |
|---|---|
| FAST: | Free Ad-Supported Television. |
| AVOD: | Ad-supported Video On Demand. |
| OTT: | “Over the Top” (delivering streamed content via Internet |
| | connected devices). |
| ad | Marker in OTT content of when to show an advertisement. |
| break: | |
| ad unit: | A kind of ad that application developers integrate into apps |
| | and display to users in order to monetize traffic (such as |
| | delivery of streamed content). |
| ad pod: | A response from an ad service containing multiple ads |
| | sequenced together to be played back-to-back. |
| ad | The process of taking a streaming video feed, inserting an |
| stitching: | advertisement video feed, and then returning to the original |
| | streaming video feed in a real-time seamless fashion. |
| slate: | A small video shown as a filler when no ad unit is available to |
| | display. |
| video ad: | An ad unit containing video and audio. |
| traditional | Refers to a video ad on connected television (CTV). This is |
| ad: | the vast majority of ads displayed on televisions today. |
| interactive | An ad unit that allows a user to interact with ad content to |
| ad: | change the ad content based on the user interaction. Audio and |
| | visuals may be executed by a variety of techniques. User |
| | interaction may be executed by various input methods. |
| SSAI: | Server side ad insertion. |
| VAST: | Video Ad Serving Template specification defined by the |
| | Interactive Advertising Bureau (IAB). |

Currently, in some free ad-supported streaming television services or other streaming video services, a content provider defines where ad breaks occur and a duration for each ad break. Even with gains in filling ads, ad fill remains below 100%. This problem exists for at least two reasons. First, ad breaks do not get ad units to cover the entire duration of the ad break. Second, whatever gap remains, that duration (usually in seconds) is an unknown until late in the process and changes from ad break to ad break.

For these or other reasons, ad breaks are not consistently filled. An ad break may not fully fill or may not fill at all for a variety of reasons. Example reasons may include frequency capping, lack of inventory, issues with ad providers, time of day, de-duping, transcoding, or other external factors. When a predetermined ad break cannot be filled, the portion that cannot be filled is filled with slate, thus losing an opportunity to monetize that portion of the ad break. This disclosure provides a solution to this type of problem by addressing both the unpredictability of an ad break getting filled and the uncertainty of unfilled ad break duration prior to occurrence of the ad break.

FIG. 1 illustrates an example network configuration 100 including an electronic device employed to dynamically supply interactive ads with minimized slate in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to minimizing slate within ad pods returned for an ad request relating to an ad break in streaming video content.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to minimizing slate within ad pods returned for an ad request relating to an ad break in streaming video content. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. In still other embodiments, the electronic device 101 can be a fixed or portable display device (such as a television) or an electronic device used in conjunction with a display device (such as a set-top box or TV box).

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to minimizing slate within ad pods returned for an ad request relating to an ad break in streaming video content.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

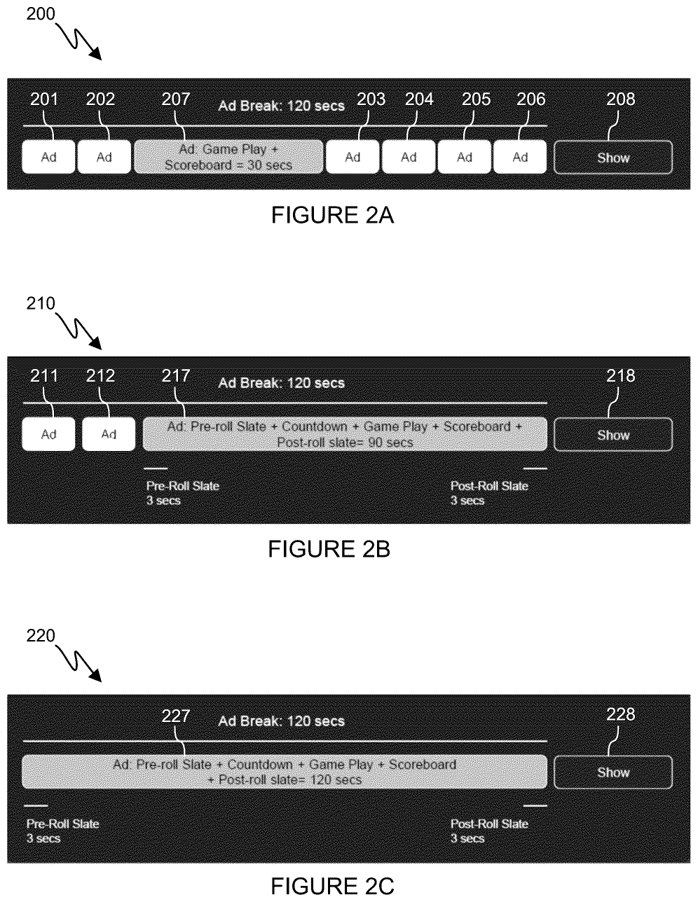

FIGS. 2A through 2C illustrate example scenarios 200, 210, 220 of dynamically supplied interactive ads with minimized slate in accordance with this disclosure. For case of explanation, the scenarios 200, 210, 220 are described as involving the use of the electronic device 101 and the server 106 in the network configuration 100 of FIG. 1. However, the scenarios 200, 210, 220 may be used with any suitable electronic device(s) and server(s) and in any other suitable system(s).

In each of FIGS. 2A through 2C, the electronic device 101 may be used to stream ad-supported content from the server 106. During streaming of the ad-supported content, a content provider requests ad content for an ad break in the content being streamed. Responsive to the request, an ad pod response 200, 210, or 220 containing zero or more traditional ads and at least one interactive ad (such as a trivia game with advertising) with little or no slate to be streamed to the electronic device 101 is returned to the server 106. In the examples of FIGS. 2A through 2C, the ad break is 120 seconds in duration, but that duration may not be known until the content provider requests ad content to fill the ad break. Moreover, the number and duration of suitable ad units available for filling the ad break may not be known until the time of the request, since ad unit inventory may vary and availability may be dependent on the time of day at which the request is sent, characteristics of the viewer of the ad-supported streaming video content, the number of advertisers interested in supplying ads, and other factors (such as frequency capping and the like).

As discussed above, in some embodiments, an interactive ad 207 may be a game, such as a trivia game with background advertising. In other embodiments, the interactive ad 207 may be an offer for a deal from a vendor, such as an offer from a pizza company with the caption “Got fuel for the game?” As a particular example, a user can switch between pre-selected items (such as pizza, breadsticks, or a combo-meal) by pressing a remote control left or right to cycle through various products. As another particular example, a quick response (QR) code unique to each product may be shown, allowing the user to scan and purchase via a mobile device. Additionally, purchases could occur on a TV or other electronic device 101 with a signed-in user, such as one having a credit card or other payment mechanism(s) on file. At a higher level, shopping experiences in many shapes and sizes could be done via “real time interactive experiences” using the interactive ads 207, with some real-time variables representing “only available now” deals and/or location-specific deals.

FIG. 2A illustrates an ad pod response 200 including traditional ad units 201-206 and an interactive ad 207 for display during an ad break in content being streamed, after which the ad-supported streaming video content 208 resumes. In some embodiments, the ad break is determined and defined by the content provider of the ad-supported streaming video content 208. In the example of FIG. 2A, ad units 201-206 meet criteria for filling the ad break. However, the combination of ad units 201-206 leaves 30 seconds of unfilled duration for the ad break. Interactive ad 207 is supplied for that unfilled duration and may be dynamically sized to any suitable length (possibly down to milliseconds) to fill the gap. In particular embodiments, the interactive ad 207 is a game. FIG. 2B illustrates an alternative ad pod response in the example scenario 210 including traditional ad units 211-212 and an interactive ad 217 for display during a 120-second ad break prior to resumption of ad-supported streaming video content 218.

FIG. 2C illustrates another alternative ad pod response in the example scenario 220 including no traditional ad units and only an interactive ad 227 for display during a 120-second ad break prior to resumption of ad-supported streaming video content 228. Interactive ads 207, 217, and 227 could include the same general content and be sized to fit the corresponding unfilled ad break duration, which is 90 seconds in the example of FIG. 2B and the full 120 seconds in the example of FIG. 2C. In some embodiments, the interactive ads 207, 217, and 227 are each a game. It should be noted that, in the examples of interactive ads 217 and 227, very brief (such as 3-second) pre-roll and post-roll slates may optionally be inserted. The ad pod responses in the example scenario 210 and the example scenario 220 are still considered to be essentially “zero” or minimized slate ad pods since no significant portion of the ad break is filled by the slate(s). Instead, the pre-roll and post-roll slate(s), which occupy 5% or less of the ad break duration, may be provided merely to permit the viewer to recognize and react to the transitions to and from interactive (versus passively-viewed) content.

Two features common to all three example ad pod responses in the example scenarios 200, 210, and 220 are (i) the interactive ad(s) 207, 217, and 227 can expand or shrink to match the unfilled duration of the requested ad break and (ii) the dynamically-filled ad request results in one or more returned interactive ads 207, 217, or 227. While depicted as permutations of 30-second increments, interactive ads 207, 217, and 227 may be other multiples of some fundamental duration (such as 10 seconds) or may be of any arbitrary duration (such as 27 seconds). Likewise, traditional ad units 201-206, 211, and 212 may have 30-second durations, 10-second durations, 20-second durations, or irregular durations such as 6 or 34 seconds. Interactive ads 207, 217, and 227 can be dynamically sized to any unfilled duration, up to and including the entire ad break duration.

Although FIGS. 2A through 2C illustrate examples of scenarios 200, 210, 220 of dynamically supplied interactive ads with minimized slate, various changes may be made to FIGS. 2A through 2C. For example, each ad break may have any suitable duration and be substantially or completely filled using any suitable number of interactive ads (with or without traditional ads).

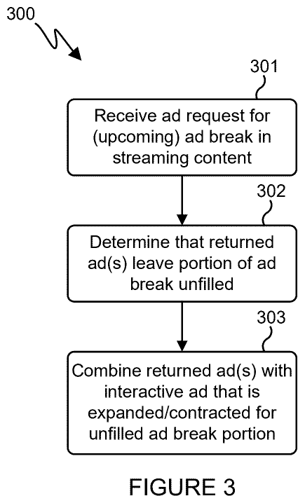

FIG. 3 illustrates an example process 300 for dynamically supplying interactive ads with minimized slate in accordance with this disclosure. For case of explanation, the process 300 is described as involving the use of the electronic device 101 and the server 106 in the network configuration 100 of FIG. 1. However, the process 300 may be used with any other suitable electronic device(s), such as the electronic device 102 or 104 and/or with any other suitable server or combination of servers and in any other suitable system(s).

The process 300 begins with receipt of an ad request for advertising to be displayed during an ad break within streaming video content (step 301). The request may indicate an advertising device identifier and/or specific capability to support dynamically supplied interactive ads. In response to receiving an indication of zero or more ads returned for the ad request, determining that an overall duration of the zero or more ads returned for the ad request leave a portion of the ad break unfilled (step 302). The determination may include a duration of the unfilled portion of the ad break. The zero or more ads returned for the ad request are combined with an interactive ad that is expanded or contracted to fit the unfilled portion of the ad break (step 303). The interactive ad includes ad content that can change based on user interaction with the ad content.

Although FIG. 3 illustrates one example of a process 300 for dynamically supplying interactive ads with minimized slate, various changes may be made to FIG. 3. For example, while shown as a series of steps, various steps in FIG. 3 could overlap, occur in parallel, occur in a different order, or occur any number of times (including zero times). Also, the specific steps shown in FIG. 3 are examples only and can easily vary depending on the circumstances.

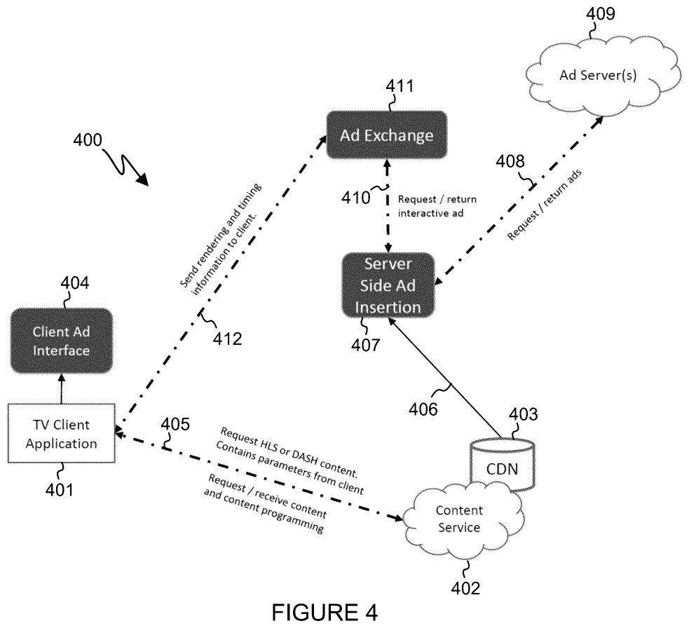

FIG. 4 illustrates an example high-level architecture 400 for dynamically supplying interactive ads with minimized slate in accordance with this disclosure. For case of explanation, the architecture 400 is described as involving the use of the electronic device 101 and the server 106 in the network configuration 100 of FIG. 1, as well as an additional (possibly third-party) ad server that might be similar to server 106. For example, a television client application 401 may execute on the electronic device 101, and a content service 402 and a content delivery network (CDN) 403 may be hosted on the server 106 and may communicate via the network 162. However, the architecture 400 may employ any suitable combination of electronic device(s) and server(s) and in any other suitable system(s).

As shown in FIG. 4, the architecture 400 includes the television client application 401, which may include or be communicably coupled to a client ad interface 404 for displaying ad pod responses (such as ad pod responses for the example scenarios 200, 210, and 220) on the display 160 of the electronic device 101, on a display of the electronic device 102 or 104, or on any other suitable display. The architecture 400 also includes the content service 402 and the CDN 403, which receive requests for content and content programming and respond with content. The content service 402 and the CDN 403 provide ad pod responses (such as ad pod responses for the example scenarios 200, 210, and 220) to the electronic device 101, the electronic device 102 or 104, or other device. The ad pod responses can be provided over a bidirectional communications link 405, such as the network 162. An ad request, such as a HyperText Transfer Protocol (HTTP) Live Streaming (HLS) or Dynamic Adaptive Streaming over HTTP (DASH) request for ad content, is sent by the television client application 401 to the content service 402 via the communications link 405. The ad request contains parameters on selection of ad content and configuration of an ad pod response, such as an indication of an ad break duration.

In response to the ad request from the television client application 401, the content service 402 sends, via CDN 403 and a unidirectional communications link 406, a corresponding ad request to a server side ad insertion (SSAI) solution 407. The SSAI solution 407 transmits a request and receives a response for ad content via at least one bidirectional communications link 408 to at least one ad server 409, which may be one or more third-party servers. Upon receiving ad content, the SSAI solution 407 sends a request and receives a return for interactive ad content to an Ad Exchange service 411 via a bidirectional communications link 410 to fill an unfilled duration for the ad break. The Ad Exchange service 411 sends rendering and timing information to the television client application 401 via a bidirectional communications link 412. The ad pod response is finalized and forwarded by the television client application 401 to the client ad interface 404 for display.

Although FIG. 4 illustrates one example of a high-level architecture 400 for dynamically supplying interactive ads with minimized slate, various changes may be made to FIG. 4. For example, various components or functions in FIG. 4 may be combined, further subdivided, replicated, omitted, or rearranged and additional components or functions may be added according to particular needs.

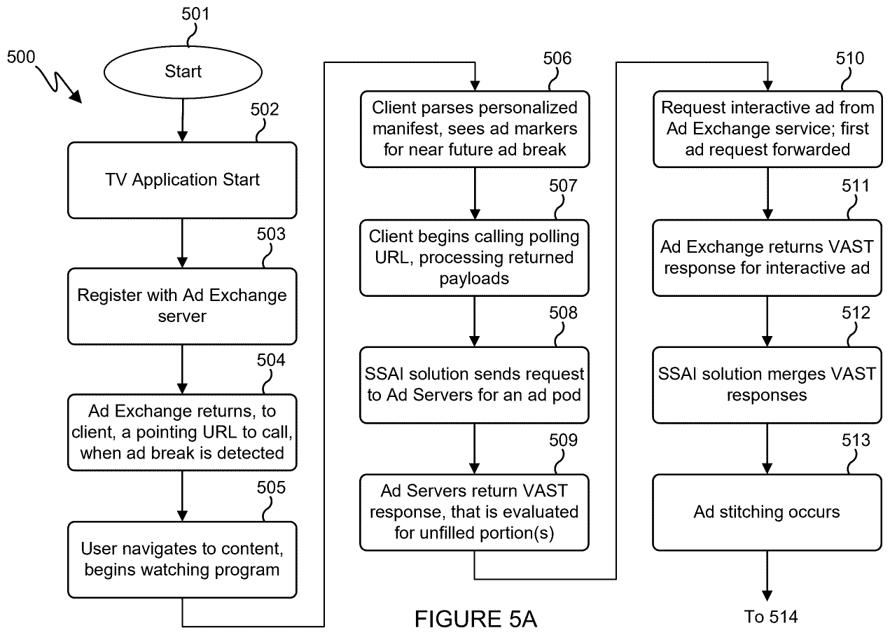

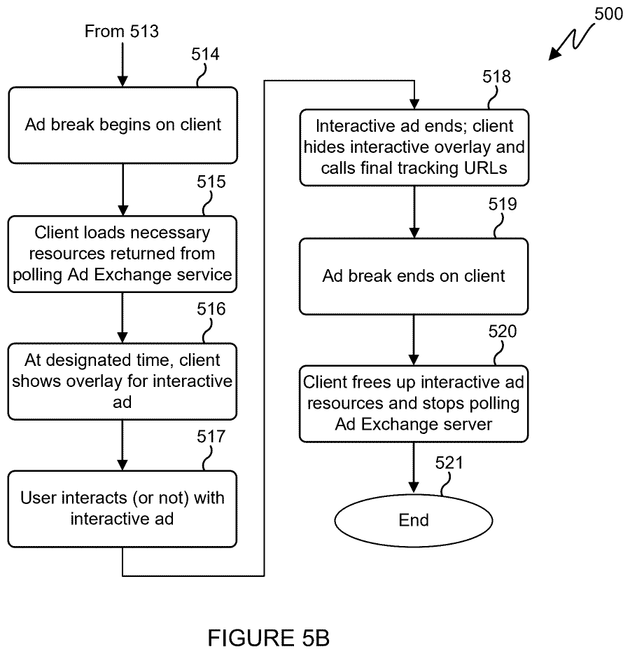

FIGS. 5A and 5B illustrate an example process 500 for dynamically supplying interactive ads with minimized slate in accordance with this disclosure. For case of explanation, the process 500 is described as involving the use of the electronic device 101 and the server 106 in the network configuration 100 of FIG. 1. However, the process 500 may be used with any other suitable electronic device(s), such as the electronic device 102 or 104 and/or with any other suitable server or combination of servers and in any other suitable system(s). In addition, the process 500 is described in conjunction with the ad service architecture 400 of FIG. 4. However, the process 500 may be used with any other suitable ad service architecture.

The process 500 begins at step 501 and is followed by start of the television client application 401 (step 502). This can include starting of a client ad interface, such as the client ad interface 404 in FIG. 4. The television client application 401 registers with the Ad Exchange service 411 (step 503). Such registration may be performed via a bidirectional communications link, such as the bidirectional communications link 412 of FIG. 4. The Ad Exchange service 411 returns, to the television client application 401, a pointing uniform resource locator (URL) to call when an ad break is detected (step 504). The pointing URL may be sent via the same bidirectional communications link as the registration request, such as the bidirectional communications link 412 of FIG. 4. The user navigates to content and begins watching the program (step 505). The content navigation may be performed in a mobile electronic device app and may include selecting specific streaming content.

The television client application 401 parses personalized manifest ad data and identifies ad markers for a near future ad break (step 506). The manifest ad data may include parameters relating to ad format, banner settings, panels, and the like. The television client application 401 begins calling a polling URL and processing returned payloads (step 507). Calls to the polling URL may be made by the television client application 401 in anticipation of each expected ad break within the content being streamed. The SSAI solution 407 sends a request for an ad pod to one or more Ad Servers 409 (step 508). The request may be a VAST request. The request may indicate a duration of the ad break for which advertising is being requested. The request may optionally indicate specific capability to support dynamically supplied interactive ads by (for instance) the television client application 401. The one or more Ad Servers 409 return at least one VAST response that is evaluated by the SSAI solution 407 for unfilled portion(s) of the ad break duration (step 509). Any indication of duration for the ad break with the request may be taken into account in evaluating the VAST response. The indicated capability to support dynamically supplied interactive ads may be taken into account in evaluating the VAST response.

The SSAI solution 407 requests one or more interactive ads for the unfilled ad break duration from the Ad Exchange service 411 (step 510), with the first ad request forwarded to the SSAI solution 407 for processing. The SSAI solution 407 may identify at least one suitable interactive ad for the unfilled ad break duration based at least in part on the personalized manifest ad data. The Ad Exchange service 411 returns at least one VAST response for one or more interactive ads (step 511), and the SSAI solution 407 merges VAST responses from the Ad Server(s) 409 and the Ad Exchange service 411 (step 512). The interactive ads are configured to expand or shrink to fill all or some part of the unfilled ad break duration. Ad stitching is performed (step 513) for multiple VAST responses. During ad stitching, non-interactive ads (if any) for the ad break are combined with the one or more interaction ads indicated by the VAST responses. When the ad break begins on the television client application 401 (step 514), the television client application 401 loads any resources necessary as returned from polling the Ad Exchange service 411 (step 515). The resources may include the overlay and any interactive user controls.

At the designated time for an interactive ad, the television client application 401 shows the overlay for the interactive ad (step 516). Display of the interactive ad replaces the streaming content for any unfilled portion of the ad break duration. The user may or may not interact with the interactive ad (step 517). For example, the user may touch a user control within the interactive ad. Alternatively, the user may simply ignore the interactive ad while being displayed. When the interactive ad ends, the television client application 401 hides the interactive overlay and calls the final tracking URLs (step 518). The final tracking URLs may be employed to distribute information regarding user interaction, if any, with the interactive ad. The ad break ends on the television client application 401 (step 519), and the television client application 401 frees up interactive ad resources and stops polling the Ad Exchange service 411 (step 520). Streaming of the content interrupted by the ad break resumes, and preparation may commence for operations relating to the next expected ad break (if any) in the streamed content. The process 500 ends (step 521).

Although FIGS. 5A and 5B illustrate one example of a process 500 for dynamically supplying interactive ads with minimized slate, various changes may be made to FIGS. 5A and 5B. For example, while shown as a series of steps, various steps in FIGS. 5A and 5B could overlap, occur in parallel, occur in a different order, or occur any number of times (including zero times). Also, the specific steps shown in FIGS. 5A and 5B are examples only and can easily vary depending on the circumstances. In addition, the process 500 is described in conjunction with the ad service architecture 400 of FIG. 4. However, the process 500 may be used with any other suitable ad service architecture.

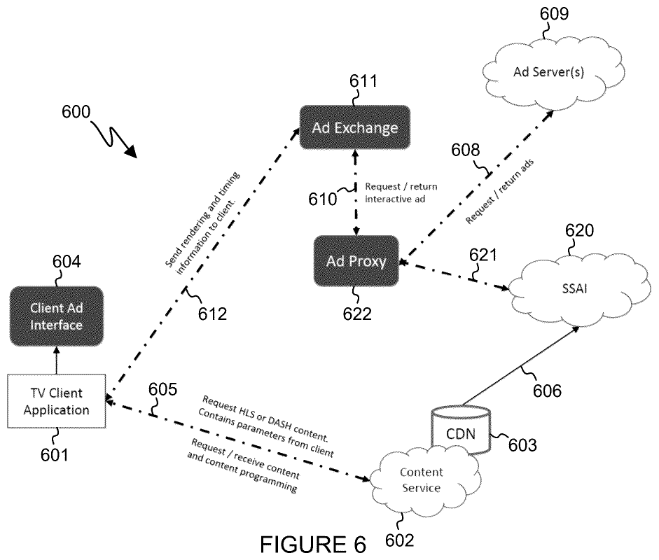

FIG. 6 illustrates another example high-level architecture 600 for dynamically supplying interactive ads with minimized slate in accordance with this disclosure. For ease of explanation, the architecture 600 is described as involving the use of the electronic device 101 and the server 106 in the network configuration 100 of FIG. 1, as well as an additional (possibly third-party) ad server that might be similar to server 106. For example, a television client application 601 may execute on the electronic device 101, and a content service 602 and a CDN 603 may be hosted on the server 106 and may communicate via the network 162. However, the architecture 600 may employ any suitable combination of electronic device(s) and server(s) and in any other suitable system(s).

Similar to the architecture 300 described above, the architecture 600 includes the television client application 601, which may include or be communicably coupled to a client ad interface 604 for displaying ad pod responses (such as ad pod responses for the example scenarios 200, 210, and 220) on the display 160 of the electronic device 101, on a display of the electronic device 102 or 104, or on any other suitable display. The architecture 600 also includes the content service 602 and the CDN 603, which receive requests for content and content programming and respond with content. The content service 602 and the CDN 603 provide ad pod responses (such as ad pod responses for the example scenarios 200, 210, and 220) to the electronic device 101, the electronic device 102 or 104, or other device. The ad pod responses are provided over a bidirectional communications link 605, such as the network 162. An ad request, such as an HLS or DASH request for ad content, is sent by the television client application 601 to the content service 602 via the communications link 605 and contains parameters on selection of ad content and configuration of an ad pod response, such as an indication of ad break duration.

In response to the ad request from the television client application 601, the content service 602 sends, via the CDN 603 and a unidirectional communications link 606, a corresponding ad request to an SSAI server 620. The SSAI server 620 transmits a request and receives a response for ad content via a bidirectional communications link 621, an ad proxy 622, and a bidirectional communications link 608 to one or more Ad Servers 609, which may be one or more third-party servers. Upon receiving ad content, the SSAI server 620 sends a request and receives a return for interactive ad content to an Ad Exchange service 611 via a bidirectional communications link 610 to fill an unfilled duration for the ad break. The Ad Exchange service 611 sends rendering and timing information to the television client application 601 via a bidirectional communications link 612. The ad pod response is finalized and forwarded by the television client application 601 to the client ad interface 604 for display.

Although FIG. 6 illustrates another example of a high-level architecture 600 for dynamically supplying interactive ads with minimized slate, various changes may be made to FIG. 6. For example, various components or functions in FIG. 6 may be combined, further subdivided, replicated, omitted, or rearranged and additional components or functions may be added according to particular needs.

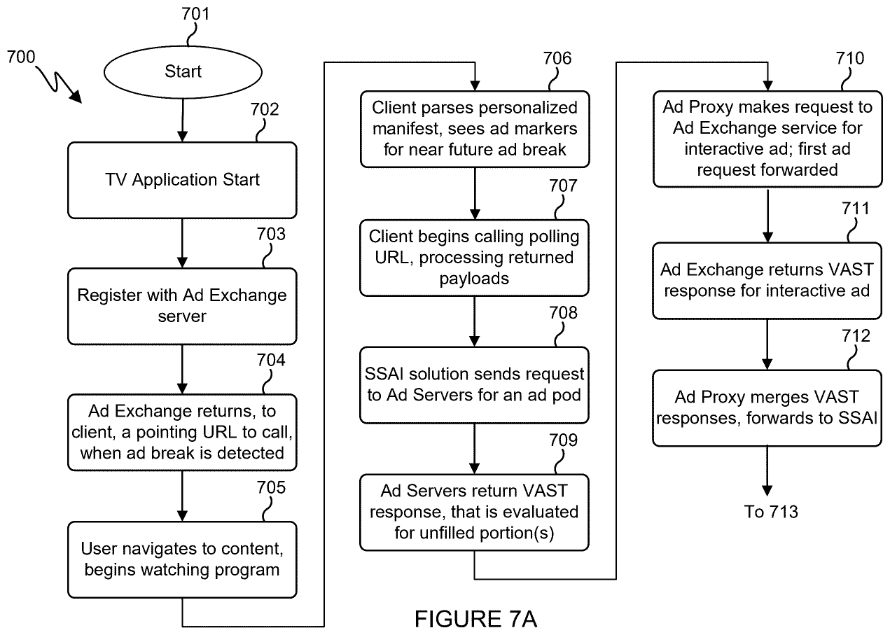

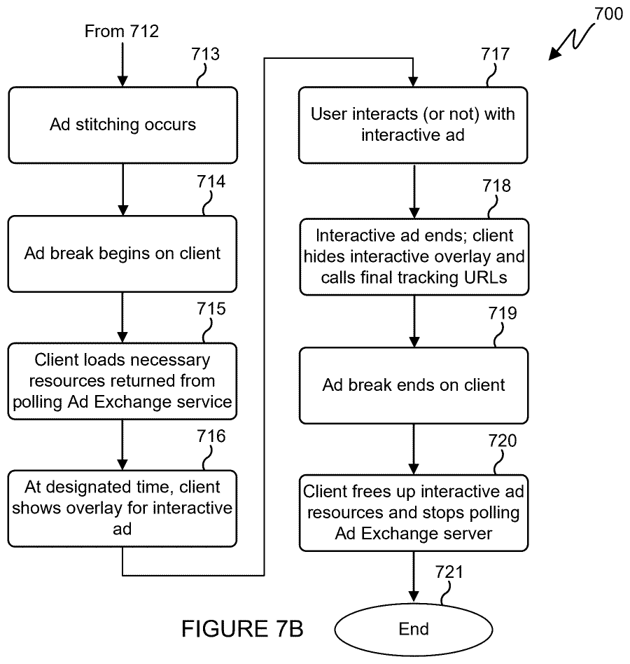

FIGS. 7A and 7B illustrate an example process 700 for dynamically supplying interactive ads with minimized slate in accordance with this disclosure. For case of explanation, the process 700 is described as involving the use of the electronic device 101 and the server 106 in the network configuration 100 of FIG. 1. However, the process 700 may be used with any other suitable electronic device(s), such as the electronic device 102 or 104 and/or with any other suitable server or combination of servers and in any other suitable system(s). In addition, the process 700 is described in conjunction with the ad service architecture 600 of FIG. 6. However, the process 700 may be used with any other suitable ad service architecture.

The process 700 begins at step 701 and is followed by start of the television client application 601 (step 702). This can include starting of a client ad interface, such as the client ad interface 604 in FIG. 6. The television client application 601 registers with the Ad Exchange service 611 (step 703). Such registration may be performed via a bidirectional communications link, such as the bidirectional communications link 612 of FIG. 6. The Ad Exchange service 611 returns, to the television client application 601, a pointing URL to call when an ad break is detected (step 704). The pointing URL may be sent via the same bidirectional communications link as the registration request, such as the bidirectional communications link 612 of FIG. 6. The user navigates to content and begins watching the program (step 705). The content navigation may be performed in a mobile electronic device app and may include selecting specific streaming content.

The television client application 601 parses personalized manifest ad data and identifies ad markers for a near future ad break (step 706). The manifest ad data may include parameters relating to ad format, banner settings, panels, and the like. The television client application 601 begins calling a polling URL and processing returned payloads (step 707). Calls to the polling URL may be made by the television client application 601 in anticipation of each expected ad break within the content being streamed. The SSAI server 620 sends a request for an ad pod to one or more Ad Servers 609 (step 708) via the communications link 621, Ad Proxy 622, and communications link 608. The request may be a VAST request. The request may indicate a duration of the ad break for which advertising is being requested. The request may optionally indicate specific capability to support dynamically supplied interactive ads by (for instance) the television client application 601. The one or more Ad Servers 609 return at least one VAST response that is evaluated by the Ad Proxy 522 for unfilled portion(s) of the ad break duration (step 709). Any indication of duration for the ad break with the request may be taken into account in evaluating the VAST response. The indicated capability to support dynamically supplied interactive ads may be taken into account in evaluating the VAST response.

The Ad Proxy 622 requests one or more interactive ads for the unfilled ad break duration from the Ad Exchange service 611 (step 710), with the first ad request forwarded for processing. At least one suitable interactive ad for the unfilled ad break duration may be identified based at least in part on the personalized manifest ad data. The Ad Exchange service 611 returns at least one VAST response for interactive ad(s) (step 711), and the Ad Proxy 622 merges VAST responses from the Ad Server(s) 609 and the Ad Exchange service 611 (step 712). The interactive ads are configured to expand or shrink to fill all or some part of the unfilled ad break duration. The Ad Proxy 622 forwards the merged VAST responses to the SSAI server 620. The merged VAST responses include the at least one interactive ad. Ad stitching is performed (step 713) for multiple VAST responses. During ad stitching, non-interactive ads (if any) for the ad break are combined with the one or more interaction ads indicated by the VAST responses. When the ad break begins on the television client application 601 (step 714), the television client application 601 loads any resources necessary as returned from polling the Ad Exchange service 611 (step 715). The resources may include the overlay and any interactive user controls.

At the designated time for an interactive ad, the television client application 601 shows the overlay for the interactive ad (step 716). Display of the interactive ad replaces the streaming content for any unfilled portion of the ad break duration. The user may or may not interact with the interactive ad (step 717). For example, the user may touch a user control within the interactive ad. Alternatively, the user may simply ignore the interactive ad while being displayed. When the interactive ad ends, the television client application 601 hides the interactive overlay and calls the final tracking URLs (step 718). The final tracking URLs may be employed to distribute information regarding user interaction, if any, with the interactive ad. The ad break ends on the television client application 601 (step 719), and the television client application 601 frees up interactive ad resources and stops polling the Ad Exchange service 611 (step 720). Streaming of the content interrupted by the ad break resumes, and preparation may commence for operations relating to the next expected ad break (if any) in the streamed content. The process 700 ends (step 721).

Although FIGS. 7A and 7B illustrate one example of a process 700 for dynamically supplying interactive ads with minimized slate, various changes may be made to FIGS. 7A and 7B. For example, while shown as a series of steps, various steps in FIGS. 7A and 7B could overlap, occur in parallel, occur in a different order, or occur any number of times (including zero times). Also, the specific steps shown in FIGS. 7A and 7B are examples only and can easily vary depending on the circumstances.

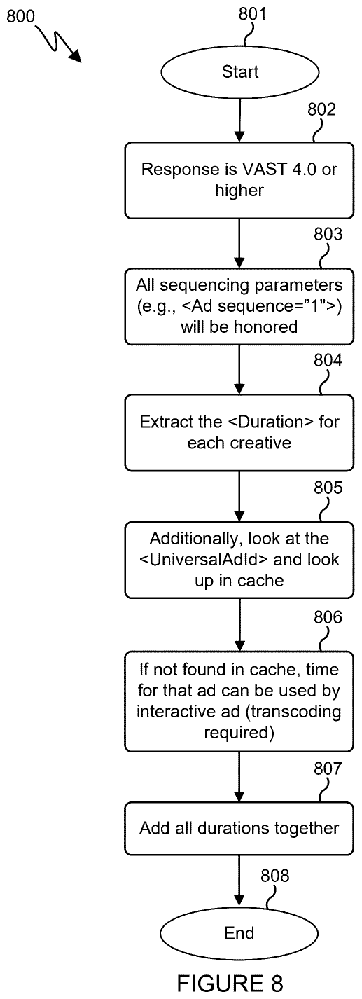

FIG. 8 illustrates an example process 800 for VAST response evaluation in accordance with this disclosure. For case of explanation, the process 800 is described as involving the use of the server 106 in the network configuration 100 of FIG. 1. However, the process 800 may be used with any other suitable device or combination of devices and in any other suitable system(s). In addition, the process 800 is described in conjunction with either the ad service architecture 400 of FIG. 4 and the process 500 of FIGS. 5A and 5B (as step 509) or the ad service architecture 600 of FIG. 6 and the process 700 of FIGS. 7A and 7B (at step 709). However, the process 800 may be used with any other suitable ad service architecture.

The process 800 begins (step 801), and a determination is made of whether a VAST response from the Ad Server(s) 309 or 509 is a VAST version 4.0 or higher (step 802). VAST 4.0 and subsequent versions support unique creative identifiers provided in the <UniversalAdId> element, as well as the sequence attribute for the <Ad> element. During evaluation of the VAST response, all sequencing parameters (such as <Ad sequence=“1”>) can be honored (step 803). That is, sequenced ads are played in numerical order (where all sequence values can be unique), and all ads in the pod may be played if possible. The duration (<Duration>) is extracted for each creative (step 804). The <Duration> element indicates the intended playback duration (runtime). In addition, the universal ad identifier (<UniversalAdId>) is examined and looked up in a cache (step 805). The <UniversalAdId> element may be used for linear ads in long-form video and may offer two attributes: one for defining the idRegistry and one for the idValue. Ad-stitching relies on the unique creative identifiers for managing the source and transcoded files for stitching into a video stream. If the corresponding ad for the universal ad identifier is not found in the cache (meaning the ad was not retrieved ahead of the ad break), the time for that ad may be used by an interactive ad (since transcoding may be required) (step 806). The option of replacing an ad that has not already been retrieved and/or transcoded with an interactive ad avoids loss of revenue due to simply failing to display any ad during the designated time. All ad durations are added together (step 807), and the process ends (step 808). Operations for a next expected ad break (if any) may commence.

Although FIG. 8 illustrates one example of a process 800 for VAST response evaluation, various changes may be made to FIG. 8. For example, while shown as a series of steps, various steps in FIG. 8 could overlap, occur in parallel, occur in a different order, or occur any number of times (including zero times). Also, the specific steps shown in FIG. 8 are examples only and can easily vary depending on the circumstances.

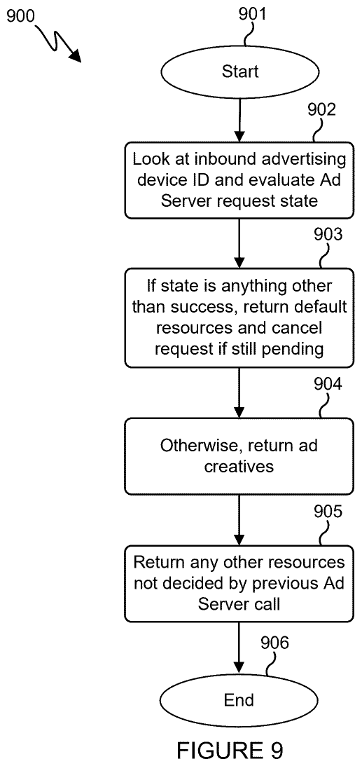

FIG. 9 illustrates an example process 900 for an Ad Exchange request/response in accordance with this disclosure. For case of explanation, the process 900 is described as involving the use of the server 106 in the network configuration 100 of FIG. 1. However, the process 900 may be used with any other suitable device or combination of devices and in any other suitable system(s). In addition, the process 900 is described in conjunction with either the ad service architecture 400 of FIG. 4 and the process 500 of FIGS. 5A and 5B (as steps 510-511) or the ad service architecture 600 of FIG. 6 and the process 700 of FIGS. 7A and 7B (at steps 710-711). However, the process 900 may be used with any other suitable ad service architecture.

The process 900 begins (step 901) with the inbound advertising device identifier (ID) being examined and the Ad Server request state being evaluated (step 902). The advertising device identifier can be associated with demographic information used for bidding on purchase of ad space. The Ad Server request can indicate whether any advertiser wishes to use part of the ad break based on the advertising device identifier and associated information. If the Ad Server request state is anything other than success, default resources are returned, and any request still pending is canceled (step 903). An Ad Server request state other than success indicates that no advertiser wishes to use all or part of the available ad break duration. Otherwise, if the Ad Server request state is success, one or more ad creatives are returned (step 904). The returned creatives, identified by the <Creatives> (plural) element and/or the <Creative> (singular) element, may nest files used for executing and tracking the ad. Any other resources not decided by the previous Ad Server call are returned (step 905), and the process ends (step 906). Subsequent ad requests are processed similarly.

Although FIG. 9 illustrates one example of a process 900 for an Ad Exchange request/response, various changes may be made to FIG. 9. For example, while shown as a series of steps, various steps in FIG. 9 could overlap, occur in parallel, occur in a different order, or occur any number of times (including zero times). Also, the specific steps shown in FIG. 9 are examples only and can easily vary depending on the circumstances.

In some embodiments, the solutions of the present disclosure target an environment in which content is linear channel programming, server-side ad stitching is performed, and ad bidding occurs in real time. The processes described above can employ a set of client and server software modules and an overall workflow that interfaces with multiple third-party vendors, allowing an interactive ad to be returned as a VAST response that is dynamically configurable in duration to fit whatever gap may occur in a current ad break. In the present disclosure, an ad exchange platform serving interactive ad units may satisfy the following requirements: the interactive ad experience can expand or shrink to match the requested ad break duration, and an ad request can result in at least one returned interactive ad. The ad exchange platform allows a blend of direct ad sales and real-time bidding. In addition, a client software development kit (SDK) may satisfy the following requirements of a set of application program interfaces (APIs) covering full client-side ad insertion lifecycle and enabling a hybrid of SSAI-side and client-side ad insertion. The client SDK may communicate with ad exchange platform as defined above. In some cases, the present disclosure eliminates or minimizes slate from FAST content, maximizing the time revenue can be earned for each ad break. Additionally, this same technique can be used with AVOD content to also remove slate.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

1. A method comprising:
receiving a Video Ad Serving Template (VAST) ad request for ads to be displayed during an ad break for streaming of video content to an electronic device, wherein the VAST ad request indicates a previously-unknown duration for the ad break;
in response to receiving a VAST response including an indication of zero or more ads returned for the VAST ad request, determining, using at least one processor, that an overall duration of the ads returned for the VAST ad request leaves an unfilled portion of the previously-unknown duration of the ad break; and
combining, using the at least one processor, the ads indicated by the VAST response returned for the VAST ad request with an interactive ad that is expanded or contracted based on one or more of pre-roll slate or post-roll slate to fit the unfilled portion of the ad break;
wherein the interactive ad includes ad content that is configured to change in content and duration based on user interaction with the ad content and minimize slate for a viewer.

2. The method of claim 1, wherein the interactive ad is combined with the ads indicated by the VAST response returned for the VAST ad request.

3. The method of claim 1, wherein server side ad insertion is employed to combine the interactive ad with the ads returned for the VAST ad request.

4. The method of claim 1, wherein the interactive ad is one of a game or an offer for a deal.

5. The method of claim 1, wherein a combination of the ads indicated by the VAST response returned for the VAST ad request and the interactive ad fill the ad break with substantially zero slate.

6. The method of claim 5, wherein the combination of the ads indicated by the VAST response returned for the VAST ad request and the interactive ad includes the one or more of pre-roll slate or post-roll slate permitting the viewer to react to one or more transitions between the ads indicated by the VAST response returned for the VAST ad request and the interactive ad.

7. The method of claim 1, further comprising:
dynamically sizing the interactive ad in response to determining that the overall duration of the ads indicated by the VAST response returned for the VAST ad request leave the unfilled portion of the ad break.

8. A video content server comprising:
a transceiver configured to receive a Video Ad Serving Template (VAST) ad request for ads to be displayed during an ad break for streaming of video content to an electronic device, wherein the VAST ad request indicates a previously-unknown duration for the ad break; and
at least one processing device configured to:
in response to receiving a VAST response including an indication of ads returned for the VAST ad request, determine that an overall duration of the ads returned for the VAST ad request leaves an unfilled portion of the previously-unknown duration of the ad break; and
combine, with the ads indicated by the VAST response returned for the VAST ad request, an interactive ad that is expanded or contracted based on one or more of pre-roll slate or post-roll slate to fit the unfilled portion of the ad break;
wherein the interactive ad includes ad content that is configured to change in content and duration based on user interaction with the ad content and minimize slate for a viewer.

9. The video content server of claim 8, wherein the interactive ad is combined with the ads indicated by the VAST response returned for the VAST ad request.

10. The video content server of claim 8, wherein server side ad insertion is employed to combine the interactive ad with the ads returned for the VAST ad request.

11. The video content server of claim 8, wherein the interactive ad is one of a game or an offer for a deal.

12. The video content server of claim 8, wherein a combination of the ads indicated by the VAST response returned for the VAST ad request and the interactive ad fill the ad break with substantially zero slate.

13. The video content server of claim 12, wherein the combination of the ads indicated by the VAST response returned for the VAST ad request and the interactive ad includes the one or more of pre-roll slate or post-roll slate permitting the viewer to react to one or more transitions between the ads indicated by the VAST response returned for the VAST ad request and the interactive ad.

14. The video content server of claim 8, wherein the at least one processing device is further configured to dynamically size the interactive ad in response to determining that the overall duration of the ads indicated by the VAST response returned for the VAST ad request leave the unfilled portion of the ad break.

15. A non-transitory machine readable medium containing instructions that when executed cause at least one processor of an electronic device to:
receive a Video Ad Serving Template (VAST) ad request for ads to be displayed during an ad break for streaming of video content to the electronic device, wherein the VAST ad request indicates a previously-unknown duration for the ad break;
in response to receiving a VAST response including an indication of ads returned for the VAST ad request, determine that an overall duration of the ads returned for the VAST ad request leaves an unfilled portion of the previously-unknown duration of the ad break; and
combine, with the ads indicated by the VAST response returned for the VAST ad request, an interactive ad that is expanded or contracted based on one or more of pre-roll slate or post-roll slate to fit the unfilled portion of the ad break;
wherein the interactive ad includes ad content that is configured to change in content and duration based on user interaction with the ad content and minimize slate for a viewer.

16. The non-transitory machine readable medium of claim 15, wherein the interactive ad is combined with the ads indicated by the VAST response returned for the VAST ad request.

17. The non-transitory machine readable medium of claim 15, wherein server side ad insertion is employed to combine the interactive ad with the ads returned for the VAST ad request.

18. The non-transitory machine readable medium of claim 15, wherein the interactive ad is one of a game or an offer for a deal.

19. The non-transitory machine readable medium of claim 15, wherein a combination of the ads indicated by the VAST response returned for the VAST ad request and the interactive ad fill the ad break with substantially zero slate.

20. The non-transitory machine readable medium of claim 19, wherein the combination of the ads indicated by the VAST response returned for the VAST ad request and the interactive ad includes the one or more of pre-roll slate or post-roll slate permitting the viewer to react to one or more transitions between the ads indicated by the VAST response returned for the VAST ad request and the interactive ad.
